(19) United States
(12) Patent Application Publication
(10) Pub. No.: US 2009/0081481 A1
(43) Pub. Date: Mar. 26, 2009

(54) Magnetic head and method of manufacturing the same

(75) Inventor: Ryuji Fujii, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE MAGNETICS (H.K) LTD., Hong Kong (CN)

(21) Appl. No.: 12/232,569

(22) Filed: Sep. 19, 2008

(30) Foreign Application Priority Data
Sep. 19, 2007 (JP) JP2007-242263

(51) Int. Cl. G11B 5/127; B05D 5/00

(52) U.S. Cl. 428/810; 427/8

(57) ABSTRACT

A plurality of magnetic heads are formed on a substrate, each of the magnetic head includes a reproducing element to read magnetic information, a recording element to write magnetic information, a reproducing element marker formed on the same plane as that on which the reproducing element is formed, and a recording element marker formed on the same plane as that on which the recording element is formed. The substrate is cut to form a bar including a plurality of the magnetic heads. The bar is held, the reproducing element marker and the recording element marker in the held bar are optically sensed, and positions of the reproducing element marker and the recording element marker are determined. A posture of the held bar is adjusted based on the positions of the reproducing element marker and the recording element marker. The bar with the posture adjusted is polished and then the polished bar is cut into individual magnetic heads.

### BACKGROUND OF THE INVENTION

1. Field of the Invention

The present invention relates to a magnetic head and a method of manufacturing the magnetic head.

2. Description of the Related Art

Examples of a recording method for magnetic recording and reproducing apparatuses such as hard disk apparatuses include a longitudinal magnetic recording method in which the direction of signal magnetization corresponds to an in-plane direction (longitudinal direction) of a recording medium and a perpendicular magnetic recording method in which the direction of signal magnetization is perpendicular to a surface of the recording medium. Compared to the longitudinal magnetic recording method, the perpendicular magnetic recording method has the advantages of not being susceptible to a thermal fluctuation in the recording medium and enabling provision of a high linear recording density.

In a common method of manufacturing a magnetic head, a plurality of magnetic heads are formed on a substrate (wafer); each of the magnetic heads includes a reproducing element to read magnetic information and a recording element to write magnetic information. The substrate is then cut into a plurality of bars each including the plurality of magnetic heads. Each of the bars is polished, and the polished bar is cut into the individual magnetic heads. For conventional magnetic heads based on the longitudinal magnetic recording method, a polishing amount is specified in order to accurately form the magnetic pole length (MR height) of the reproducing element. Specifically, the following method is adopted which uses a measuring instrument that outputs a signal when the magnetic pole length of the reproducing element is appropriate. While a polishing target surface (a air bearing surface located above and opposite the magnetic recording medium at the time of completion) of each of the bars is being polished, signals from the measuring instrument are observed. Once the appropriate signal is output, the polishing is ended. This method is adopted because reliable reading of a very weak magnetic force recorded in the magnetic recording medium is significantly affected by the magnetic pole length of the reproducing element. However, the magnetic pole length (neck height) of the recording element is not required to be as accurate as the magnetic pole length of the reproducing element.

In contrast, magnetic heads based on the perpendicular magnetic recording method are denser than those based on the longitudinal magnetic recording method. Thus, for the magnetic heads based on the perpendicular magnetic recording method, the magnetic pole length of the recording element significantly affects recording characteristics. Therefore, similarly to the magnetic pole length of the reproducing element, the magnetic pole length of the recording element needs to be accurately formed.

To be polished, the bar is generally attached to a processing jig and pressed against a grinding machine. If the bar is tilted when attached to the processing jig, the tilt may cause a variation in the magnetic pole height of the recording element.

Thus, Japanese Patent Application Laid-Open No. 2006-172691 discloses a method of polishing the polishing target surface (air bearing surface) of the magnetic head, using an optical angle measuring instrument such as a laser auto collimator to adjust the angle between an element forming surface and the polishing target surface (air bearing surface) of the magnetic head. Furthermore, Japanese Patent Application Laid-Open No. 2006-331562 discloses a method of adjusting the angle of the polishing target surface on the basis of the magnetic pole heights of the reproducing element and the recording element.

According to the method described in Japanese Patent Application Laid-Open No. 2006-172691, if the reproducing element and recording element formed on the substrate are already misaligned, the misalignment between the reproducing element and the recording element cannot be corrected even by adjusting the angle between the element forming surface and the polishing target surface (air bearing surface). Even when the magnetic pole height of the reproducing element can be accurately formed, that of the recording element cannot be accurately formed at the same time.

Furthermore, according to the method described in Japanese Patent Application Laid-Open No. 2006-331562, a scanning electron microscope (SEM) is used to actually measure the lengths of the reproducing element and the recording element so that on the basis of the measured lengths, the tilt of the bar can be calculated. This operation requires a long time. Furthermore, a significant measurement error may be involved in the determination of the magnetic pole height of the recording element. As a result, a significant error may be involved in the calculation of the tilt of the bar. Therefore, achieving the required high accuracy is difficult.

### SUMMARY OF THE INVENTION

An object of the present invention is to provide a magnetic head and a method of manufacturing the magnetic head which allow the magnetic pole heights of a recording element and a reproducing element to be accurately formed by easy and quick processing.

A method of manufacturing a magnetic head according to the present invention is characterized in that the method comprising steps of forming a plurality of magnetic heads on a substrate, each of the magnetic head including a reproducing element to read magnetic information, a recording element to write magnetic information, a reproducing element marker formed on the same plane as that on which the reproducing element is formed, and a recording element marker formed on the same plane as that on which the recording element is formed; cutting said substrate to form a bar including a plurality of the magnetic heads; determining a position of the reproducing element marker and a position of the recording element marker by holding the bar and optically sensing the reproducing element marker and the recording element marker in the bar which is held; adjusting a posture of the bar which is held, based on the position of the reproducing element marker and the position of the recording element marker; polishing the bar with the posture adjusted; and cutting the bar which was polished into individual magnetic heads.

The term “bar” as used herein is not limited to a bar including one row of magnetic heads but may be an assembly of a plurality of bars including a plurality of rows of magnetic heads. In this case, when the assembly is cut into individual magnetic heads, the assembly is cut into individual rows of magnetic heads (that is, into individual bars) and each of the bars is further divided into individual magnetic heads. Such an assembly of a plurality of bars is also referred to as a block (stack).

The step of determining a position of the reproducing element marker and a position of the recording element marker includes optically sensing transmission images, which are transmitted through a part of the magnetic head, of the reproducing element marker and the recording element marker that are not exposed from a surface of the magnetic head.

The step of forming the magnetic head includes simultaneously forming the reproducing element and the reproducing element marker using the same material, and also includes simultaneously forming the recording element and the recording element marker using the same material. A relative positional relationship between the reproducing element and the reproducing element marker is specified, and a relative positional relationship between the recording element and the recording element marker is specified. However, the reproducing element and the reproducing element marker may be formed using different materials. The recording element and the recording element marker may be formed using different materials. Also in this case, a relative positional relationship between the reproducing element and the reproducing element marker is specified. A relative positional relationship between the recording element and the recording element marker is specified.

Holding the bar is performed by attaching the bar to a processing jig. The step of adjusting a posture of the bar comprises adjusting the attachment posture in which the bar is attached to the processing jig.

According to this method, if the positions of the reproducing element and the recording element are misaligned, the misalignment can be corrected by adjusting the posture of the bar, for example, by adjusting the holding posture in which the bar is held by the processing jig, and then the bar with the posture adjusted can be polished. Adjusting the posture of the bar allows the bar to be polished so that the magnetic pole lengths of the reproducing element and the recording element can both be accurately formed.

The step of adjusting a posture of the bar preferably comprises, if the position of the reproducing element marker and the position of the recording element marker are correctly aligned, a step of holding the bar by attaching the bar to the processing jig with the posture of the bar adjusted such that the bar is located perpendicularly to the processing jig, and if the position of the reproducing element marker and the position of the recording element marker are misaligned, a step of holding the bar by attaching the bar to the processing jig with the posture of the bar adjusted such that the bar is located obliquely to the processing jig at an angle corresponding to the misalignment. Then, during polishing the bar, the bar can be held in the same posture and perpendicularly to a grinding machine without tilting processing jig 15, in both rough polishing and fine polishing. This prevents a variation in magnetic height among elements resulting from a variation in the processing rate. Furthermore, an area that is particularly difficult to polish is unlikely to be formed in the bar. This eliminates the need to increase the polishing amount more than is required, because it is unnecessary to consider an area that is particularly difficult to polish.

Moreover, the step of adjusting a posture of the bar includes adjusting an angle of the bar in a width direction and adjusting an angle of the bar in a longitudinal direction. In this case, possible misalignment between the reproducing element marker and the recording element marker is sensed in two directions, and then the angle of the bar is adjusted in the two directions. This significantly improves accuracy.

A magnetic head according to the present invention is characterized in that the magnetic head comprises a reproducing element to read magnetic information, a recording element to write magnetic information, a reproducing element marker formed on the same plane on which the reproducing element is formed, and a recording element marker formed on the same plane on which the recording element is formed. Preferably, the reproducing element marker is formed simultaneously with the reproducing element using the same material as that of that reproducing element, and a relative positional relationship between the reproducing element and the reproducing element marker is specified. Also preferably, the recording element marker is formed simultaneously with the recording element using the same material as that of the recording element, and a relative positional relationship between the recording element and the recording element marker is specified.

According to the present invention, the bar can be held in the correct posture by adjusting the posture of the bar in both cases in which the reproducing element marker and the recording element marker are misaligned on the substrate and in which the bar is firstly held in an incorrect posture. Performing polishing the bar with the posture adjusted as mentioned above, enables the magnetic pole heights of both the reproducing element and the recording element to be accurately formed. Furthermore, the positions of the reproducing element marker and the recording element marker are optically sensed and then possible misalignment between the reproducing element marker and the recording element marker are calculated. This allows processing to be achieved much faster than processing for actual calculations of the magnetic pole length of each element.

The above and other objects, features and advantages of the present invention will become apparent from the following description with reference to the accompanying drawings which illustrate examples of the present invention.

### BRIEF DESCRIPTION OF THE DRAWINGS

FIG. 1 is a schematic perspective view showing a substrate according to an embodiment of the present invention;

FIG. 2 is an enlarged view of an essential part of FIG. 1;

FIG. 3 is a sectional view of a magnetic head formed on the substrate shown in FIG. 1;

FIG. 4 is a schematic view of the magnetic head as viewed from an air bearing surface side;

FIG. 5 is a perspective view showing a bar obtained by cutting the substrate shown in FIG. 1;

FIG. 6 is a schematic view showing that the bar shown in FIG. 5 is attached to a processing jig;

FIG. 7 is a schematic view showing that a reproducing element marker and a recording element marker in the bar shown in FIG. 6 are not misaligned;

FIG. 8 is a schematic view showing an example in which the reproducing element marker and the recording element marker in the bar shown in FIG. 6 are misaligned;

FIG. 9 is a schematic view illustrating adjustment of the posture of the bar in the condition shown in FIG. 8;

FIG. 10 is a schematic view showing another example in which the reproducing element marker and the recording element marker in the bar shown in FIG. 6 are misaligned;

FIG. 11 is an example of a graph showing detected values for the positions of the reproducing element marker and the recording element marker in the bar as well as the amount of misalignment;

FIG. 12 is another example of a graph showing detected values for the positions of the reproducing element marker and the recording element marker in the bar as well as the amount of misalignment;

FIG. 13 is a schematic view showing a step for polishing the bar shown in FIG. 6;

FIG. 14 is a perspective view showing a magnetic head obtained by cutting the bar shown in FIG. 5;

FIG. 15 is a schematic view illustrating a step for adjusting the angle of the bar in a direction different from that in FIG. 9;

FIG. 16A is a schematic view of attachment step, illustrating a common attachment condition in which the bar is attached to a processing jig;

FIG. 16B is a schematic view of rough polishing step, illustrating a common attachment condition in which the bar is attached to the processing jig;

FIG. 16C is a schematic view of fine polishing step, illustrating a common attachment condition in which the bar is attached to the processing jig;

FIG. 17A is a schematic view of attachment step, illustrating another attachment condition in which the bar is attached to the processing jig;

FIG. 17B is a schematic view of rough polishing step, illustrating another attachment condition in which the bar is attached to the processing jig;

FIG. 17C is a schematic view of fine polishing step, illustrating another attachment condition in which the bar is attached to the processing jig; and

FIG. 18 is a perspective view showing a block obtained by cutting the substrate shown in FIG. 1.

### DETAILED DESCRIPTION OF THE PREFERRED EMBODIMENTS

An embodiment of the present invention will be specifically described with reference to the drawings.

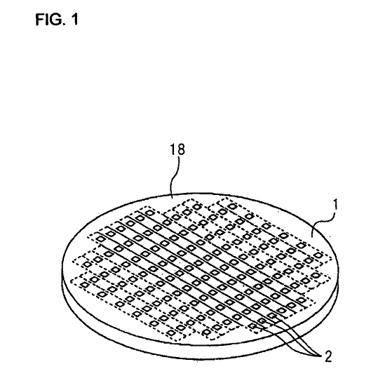

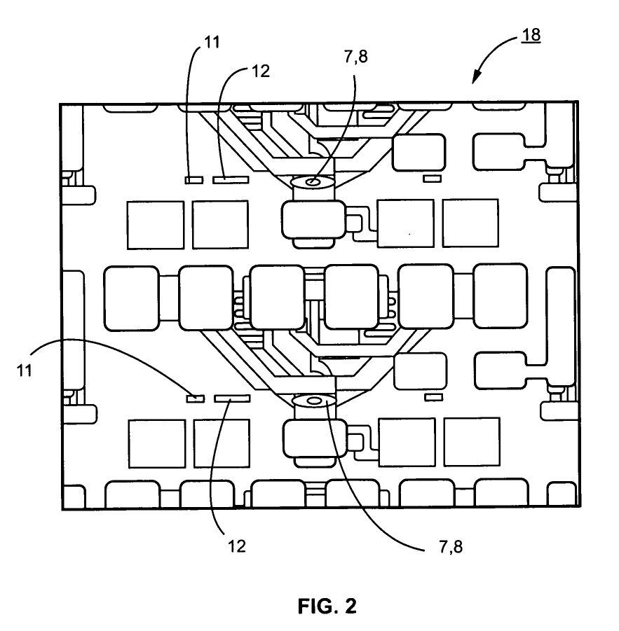

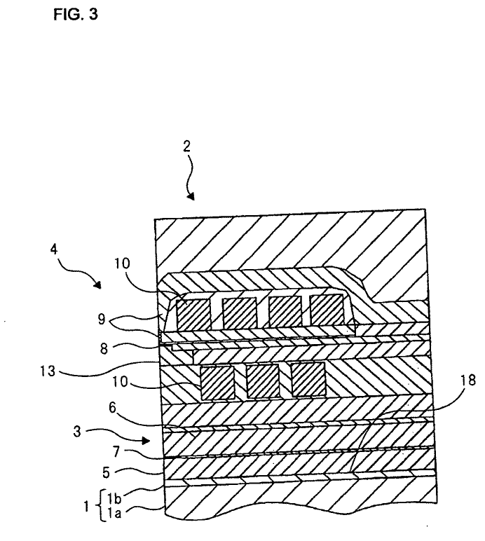

According to a method of manufacturing a magnetic head, according to the present embodiment, first, a large number of magnetic heads 2 are formed on substrate (wafer)1 as shown in FIGS. 1 to 4. For example, as shown in FIG. 3, magnetic heads 2 each including reproducing section 3 and recording section 4 are formed, in a matrix, on substrate 1 composed of base 1a of Altic (Al₂O₃·TiC) and underlayer 1b made up of an insulating material such as alumina (Al₂O₃) laminated on base 1a. Reproducing section 3 is composed of lower shield layer 5 on substrate 1, upper shield layer 6, and reproducing element 7 sandwiched between lower shield layer 5 and upper shield layer 6. Reproducing element 7 may be, for example, a TMR (Tunneling Magneto Resistance) element with an insulating layer sandwiched between paired magnetic substance layers. On the other hand, recording section 4 performs magnetic recording according to a perpendicular magnetic recording (PMR) method. Recording section 4 is mainly composed of a main magnetic pole serving as recording element 8, auxiliary magnetic pole 9, and thin film coil 10. In FIGS. 2 and 4, reproducing element 7 and recording element 8 are arranged planarly at the same position.

In the present embodiment, reproducing element marker 11 is formed simultaneously with reproducing element 7. Recording element marker 12 is formed simultaneously with recording element 8. Reproducing element marker 11 is a layer made of the same material as that of one of the layers forming reproducing element 7 or is a stack of the same configuration as that of reproducing element 7. The relative position with respect to reproducing element 7 is specified for reproducing element marker 11. Furthermore, recording element marker 12 is a layer made of the same material as that of recording element (main magnetic pole) 8. The relative position with respect to recording element 8 is specified for recording element marker 12. The planar size of reproducing element marker 11 and recording element marker 12 is about 5 μm×10 μm. Alternatively, the longitudinal dimensions of reproducing element marker 11 and recording element marker 12 may differ from each other so as to allow markers 11 and 12 to be easily distinguished from each other.

As shown in FIG. 4, in air bearing surface (ABS) 13 located above and opposite a magnetic recording medium (not shown in the drawings), when magnetic head 2 is completed, reproducing element 7 and reproducing element marker 11 are positioned in the same plane, that is, at the same height. Recording element 8 and recording element marker 12 are also positioned in the same plane (at the same height). Thus, magnetic head 2 is formed, which includes reproducing element 7, reproducing element marker 11, recording element 8, and recording element marker 12. As shown in FIG. 1, according to the present embodiment, a large number of reproducing elements 7, reproducing element markers 11, recording elements 8, and recording element markers 12 are provided so that a large number of magnetic heads 2 are arranged in a matrix.

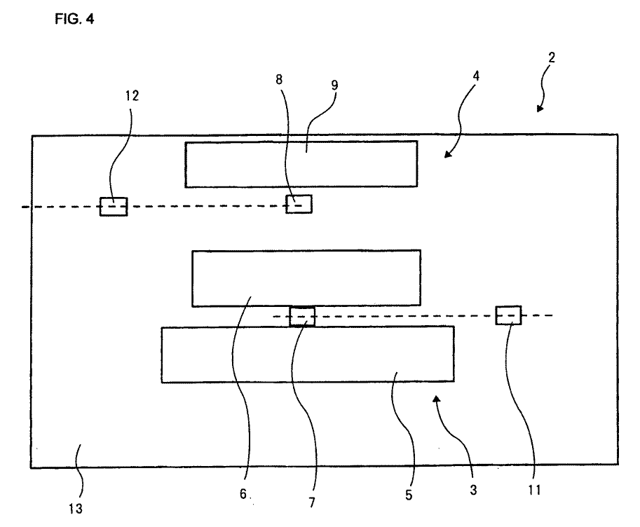

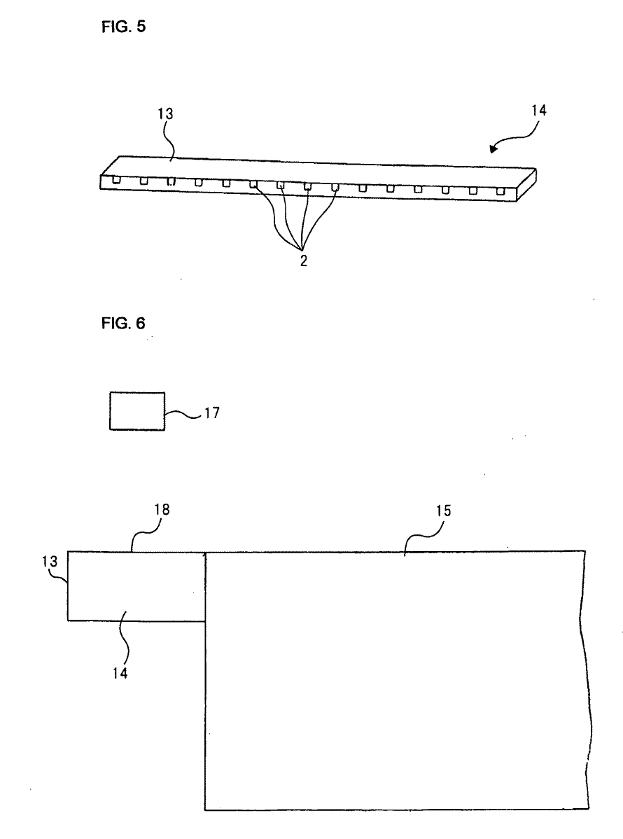

Then, substrate 1 with the large number of magnetic heads 2 arranged in a matrix is cut into a plurality of elongate bars 14 (see FIG. 5). The large number of magnetic heads 2 are arranged in bar 14.

Then, as schematically shown in FIG. 6, bar 14 is attached to processing jig 15. Optical sensor 17 is then used to sense the positions of reproducing element marker 11 and recording element marker 12 from above element forming surface 18 of bar 14. The term “element forming surface 18” as used herein refers to a top surface of substrate 1 on which the layers are formed and a surface of substrate 1 which is parallel to the top surface.

Reproducing element marker 11 and recording element marker 12 are not exposed from the surface of magnetic head 2 in bar 14. However, at least on element forming surface 18 side, the layers of each of magnetic heads 2 are very thin and are made up of a translucent material. Thus, transmission images of reproducing element marker 11 and recording element marker 12 can be sensed by optical sensor 17.

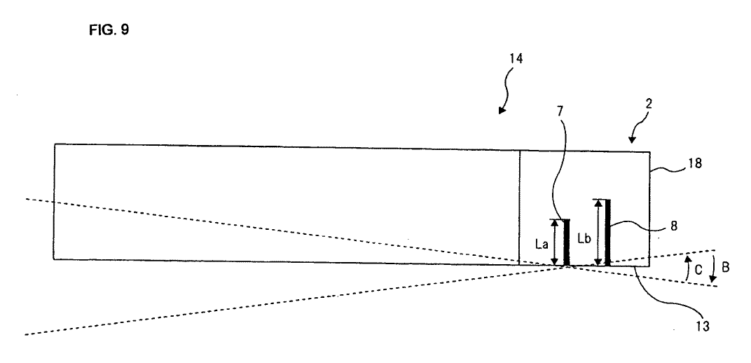

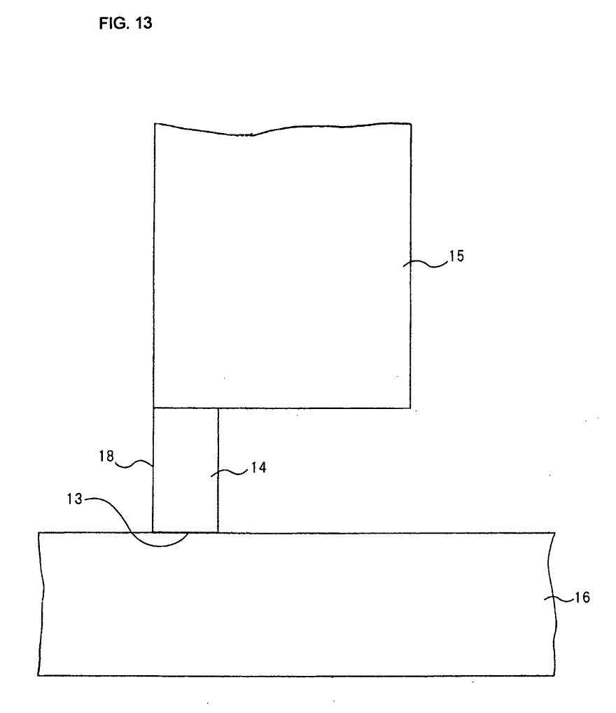

On the basis of the thus determined positions of reproducing element marker 11 and recording element marker 12, whether or not bar 14 attached to processing jig 15 is in correct alignment is checked. To carry out the check, the relative positional relationship of reproducing element marker 11 and recording element marker 12 is predetermined so as to simultaneously obtain desired magnetic pole length La of reproducing element 7 and desired magnetic pole length Lb of recording element 8 (see FIG. 9) when bar 14 is pressed against grinding machine 16 (see FIG. 13) during the polishing step described below. The predetermined positional relationship is then compared with the positional relationship between reproducing element marker 11 and recording element marker 12 sensed by optical sensor 17. By way of example, as shown in FIG. 7, if center line (A) of reproducing element marker 11 aligns with center line (B) of recording element marker 12 on element forming surface 18, it is determined that reproducing element marker 11 and recording element marker 12 are not misaligned on substrate 1. The polishing step described below is then carried out. FIG. 7 and FIGS. 8 and 10, described below, are enlarged views of element forming surface 18 of bar 14 recognized by optical sensor 17. However, for the sake of easily seeing the figures, only reproducing element marker 11 and recording element marker 12 in bar 14 are shown, with the illustration of members such as reproducing element 7 and recording element 8 omitted.

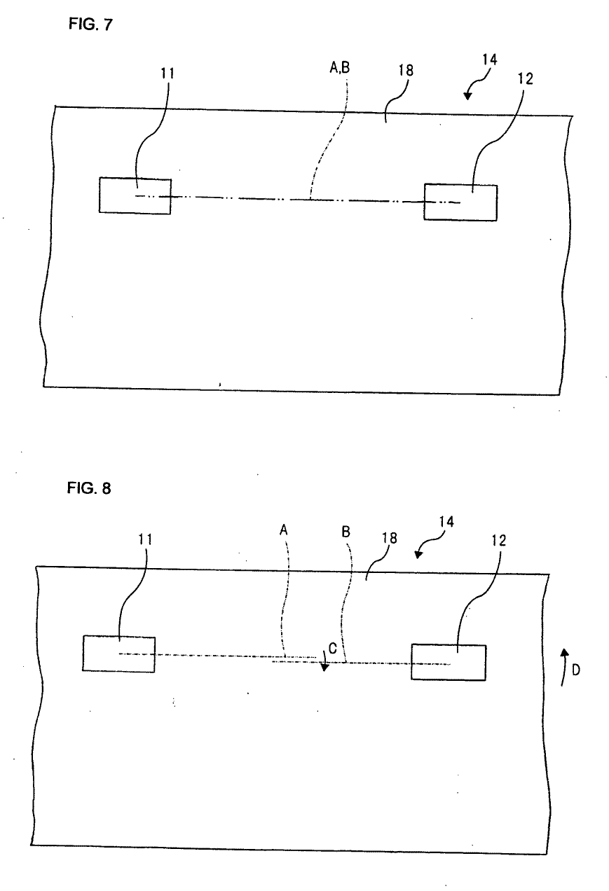

In contrast, as shown in FIG. 8, when center line (B) of recording element marker 12 is displaced from center line (A) of reproducing element marker 11 in the direction of arrow (C) on element forming surface 18, then bar 14 is rotated in the direction of arrow (D). The rotation is performed by adjusting the posture of bar 14 and particularly the angle of bar 14 in a width direction thereof as shown in FIG. 9. The angle is thus adjusted (bar 14 is obliquely tilted) so that reproducing element marker 11 and recording element marker 12 are positioned on the same horizontal straight line as accurately as possible.

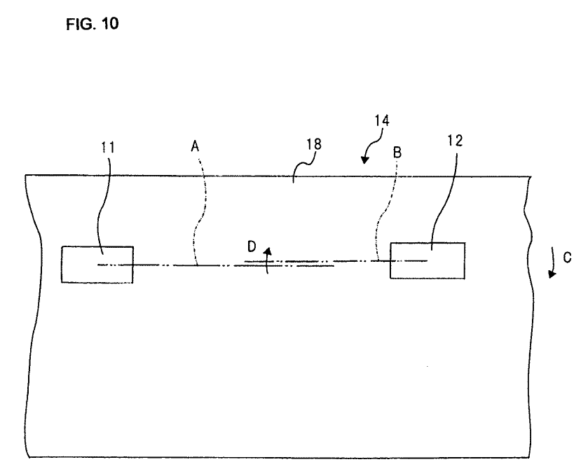

Furthermore, as shown in FIG. 10, when center line (B) of recording element marker 12 is displaced from center line (A) of reproducing element marker 11 in the direction of arrow (D) on element forming surface 18, then bar 14 is rotated in the direction of arrow (C). The rotation is performed by adjusting the posture of bar 14 and particularly the angle of bar 14 in the width direction thereof as shown in FIG. 9. The angle is thus adjusted (bar 14 is obliquely tilted) so that reproducing element marker 11 and recording element marker 12 are positioned on the same horizontal straight line as accurately as possible.

When the angle of bar 14 is adjusted as shown in FIGS. 8 to 10, then after the angle of bar 14 is adjusted, optical sensor 17 is used to sense the positions of reproducing element marker 11 and recording element marker 12 again. If the angle adjustment is insufficient and reproducing element marker 11 and recording element marker 12 still fail to lie on the same horizontal straight line, the angle is adjusted again. Thus, a feedback loop may be constructed in which the following steps are repeated a number of times: a step for sensing of the positions of reproducing element marker 11 and recording element marker 12 and a steps for adjusting the angle of bar 14 based on the sensed positions, and then once the misalignment between reproducing element marker 11 and recording element marker 12 falls within a predetermined allowable range, the process shifts to the polishing step described below.

According to the present embodiment, the plurality of magnetic heads 2 are present in bar 14, and each of magnetic heads 2 includes reproducing element 7 and recording element 8 as well as reproducing element marker 11 and recording element marker 12. Thus, the positional relationship between reproducing element 7 and recording element 8 in the longitudinal direction of bar 14 can be indirectly determined by detecting the positions of a plurality of reproducing element markers 11 and recording element markers 12. The positional relationship is thus determined so that the optimum angle of the bar is set on the basis of the positional relationship. Specifically, if the positional relationship between reproducing element marker 11 and recording element marker 12 is correctly aligned, that is, if the positional relationship between reproducing element 7 and recording element 8 is correctly aligned, bar 14 is attached to processing jig 15 with the posture thereof adjusted so as to be perpendicular to processing jig 15 described below.

In contrast, if the positional relationship between reproducing element marker 11 and recording element marker 12 is incorrectly aligned, that is, if the positional relationship between reproducing element 7 and recording element 8 is incorrectly aligned, then bar 14 is attached to processing jig 15 with the posture thereof adjusted so as to be oblique to processing jig 15. Bar 14 is thus located obliquely to processing jig 15 so as to be pressed against grinding machine 16 (see FIG. 13) in substantially the same posture as that taken by bar 14 when reproducing element 7 and recording element 8 are positioned correctly. The angle at which bar 14 is located obliquely to processing jig 15 is determined on the basis of the positions of reproducing element marker 11 and recording element marker 12.

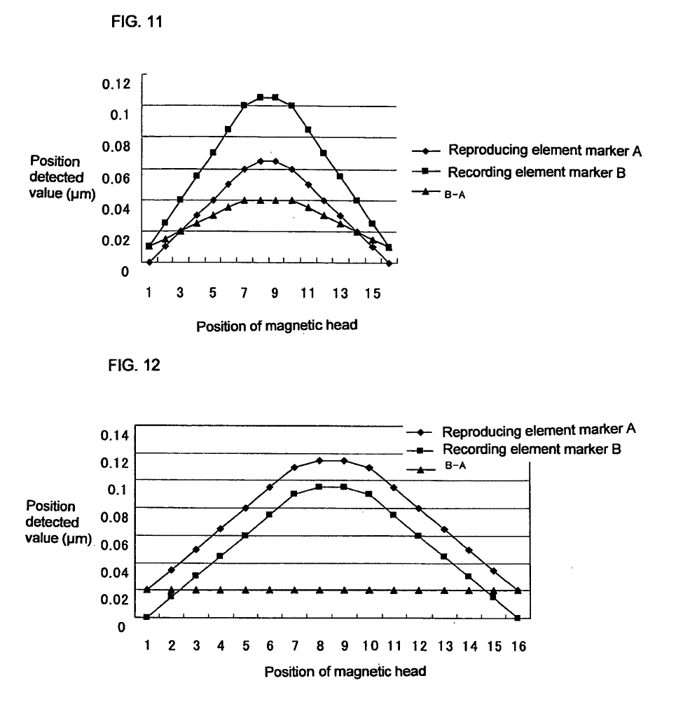

A specific example will be described. For example, in bar 14 with the large number of magnetic heads 2, sixteen magnetic heads 2 were extracted at fixed intervals. Position detected value A for reproducing element marker and position detected value B for recording element marker 12 were determined, and the difference between position detected values A and B, that is, misalignment amount (A-B), was determined. The results are shown in Table 1 shown below and FIG. 11. Position detected values A and B indicate distances between a horizontal reference line (not shown in the drawings) and center lines A and B, described above.

TABLE 1

| | Position detected | Position detected | |
|---|---|---|---|
| | value A(μm) for | value B(μm) for | |
| | the reproducing | the recording | Misalignment |
| No. | element marker | element marker | amount (A − B) |
| 1 | 0 | 0 | 0 |
| 2 | 0.015 | 0.01 | 0.005 |
| 3 | 0.03 | 0.02 | 0.01 |
| 4 | 0.045 | 0.03 | 0.015 |
| 5 | 0.06 | 0.04 | 0.02 |
| 6 | 0.075 | 0.05 | 0.025 |
| 7 | 0.09 | 0.06 | 0.03 |
| 8 | 0.095 | 0.065 | 0.03 |
| 9 | 0.095 | 0.065 | 0.03 |
| 10 | 0.09 | 0.06 | 0.03 |
| 11 | 0.075 | 0.05 | 0.025 |
| 12 | 0.06 | 0.04 | 0.02 |
| 13 | 0.045 | 0.03 | 0.015 |
| 14 | 0.03 | 0.02 | 0.01 |
| 15 | 0.015 | 0.01 | 0.005 |
| 16 | 0 | 0 | 0 |

On the basis of misalignment amounts (A-B) of sixteen magnetic heads 2, the posture of bar 14 is set as close as possible to the posture in which the misalignment is 0. For example, the amounts shown in Table 1 show that the average of misalignment amounts (A-B) is about 0.017 μm. Thus, entire bar 14 is tilted so as to be displaced by 0.017 μm from reproducing element marker 11 toward recording element marker 12. In short, bar 14 is attached to processing jig 15 with the posture of bar 14 adjusted such that bar 14 is located obliquely to processing jig 15 at an angle determined by the distance between reproducing element marker 11 and recording element marker 12 as well as the average value (for example, 0.017 μm) of misalignment amounts (A-B). This allows accurate polishing to be easily achieved as described below, thus enabling prevention of a possible decrease in yield.

The data shown in Table 1 was measured with bar 14 attached to processing jig 15. When bar 14 is bonded to processing jig 15, release of the internal stress of substrate 1 or the bonding strain causes bar 14 to be bent. The bending of bar 14 is expressed by the misalignment between markers 11 and 12. The example shown in Table 1 and FIG. 11 indicates the positions of markers 11 and 12 observed when the positions of reproducing element markers 11 located at the opposite ends of bar 14 are defined as 0. The positions of markers 11 and 12 indicate the bending amount of bar 14. In general, the bar is often bent like a second-order curve as shown in Table 1 and FIG. 11. In this example, bar 14 is bent in a protruding second-order curve. However, bar 14 may be bent in a recess. In the example shown in Table 1 and FIG. 11, since the line joining reproducing element markers 11 together is not parallel to the line joining recording element markers 12 together, misalignment (A-B) is not fixed. Consequently, even adjustment of the attachment angle at which bar 14 is attached to processing jig 15 fails to set the positions of all reproducing element markers 11 and recording element markers 12 in bar 14 to 0. Nevertheless, by using the average value of misalignment amounts (A-B) to adjust the attachment angle, misalignment amount (A-B) can be set as close to 0 as possible during re-measurement after adjustment. Thus, a possible yield loss can be minimized.

Table 2 and FIG. 12 shown position detected values A and B of markers 11 and 12 in another example of bar 14 as well as misalignment amount (A-B).

TABLE 2

| | Position detected | Position detected | |
|---|---|---|---|
| | value A(μm) for | value B(μm) for | |
| | the reproducing | the recording | Misalignment |
| No. | element marker | element marker | amount (A − B) |
| 1 | 0 | 0.02 | 0.02 |
| 2 | 0.015 | 0.035 | 0.02 |
| 3 | 0.03 | 0.05 | 0.02 |
| 4 | 0.045 | 0.065 | 0.02 |
| 5 | 0.06 | 0.08 | 0.02 |
| 6 | 0.075 | 0.095 | 0.02 |
| 7 | 0.09 | 0.11 | 0.02 |
| 8 | 0.095 | 0.115 | 0.02 |
| 9 | 0.095 | 0.115 | 0.02 |
| 10 | 0.09 | 0.11 | 0.02 |
| 11 | 0.075 | 0.095 | 0.02 |
| 12 | 0.06 | 0.08 | 0.02 |
| 13 | 0.045 | 0.065 | 0.02 |
| 14 | 0.03 | 0.05 | 0.02 |
| 15 | 0.015 | 0.035 | 0.02 |
| 16 | 0 | 0.02 | 0.02 |

In the example shown in Table 2 and FIG. 12, the line joining reproducing element markers 11 together is parallel to the line joining recording element markers 12 together. Thus, misalignment amount (A-B) is fixed. Consequently, adjusting the attachment angle at which bar 14 is attached to processing jig 15 allows the positions of all reproducing element markers 11 and recording element markers 12 in bar 14 to be set to 0.

The two examples descried above involve very regular misalignment amounts (A-B). However, of course, more irregular misalignments may occur. Even in such a case, the positions of all reproducing element markers 11 and recording element markers 12 in bar 14 can be set closer to 0 by using the average value of misalignment amounts (A-B) to adjust the attachment angle at which bar 14 is attached to processing jig 15, as is the case with the above-described examples.

If reproducing element marker 11 and recording element marker 12 are not misaligned as shown in FIG. 7, and after the angle of bar 14 is adjusted (bar 14 is obliquely tilted) so as to position reproducing element marker 11 and recording element marker 12 on the same horizontal straight line as in the case of the above-described two examples, the polishing target surface (air bearing surface 13) of bar 14 is pressed against grinding machine 16 for polishing as shown in FIG. 13. As a result, both magnetic pole length La of reproducing element 7 and magnetic pole length Lb of recording element 8 can be set to the desired values.

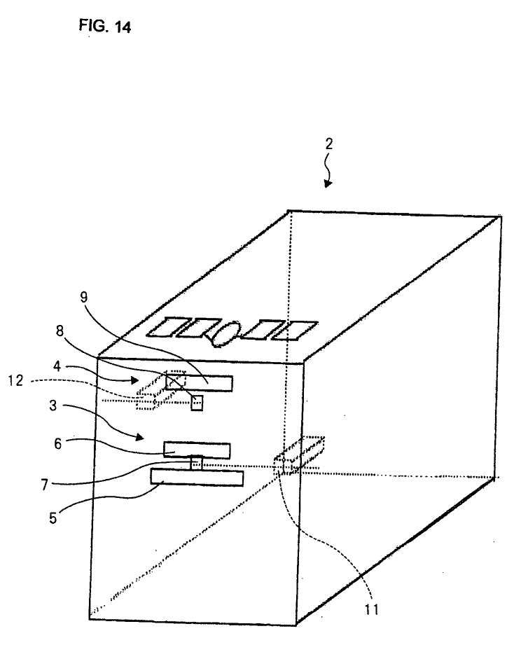

Finally, thus polished bar 14 is cut into individual magnetic heads 2 to allow a plurality of magnetic heads 2 shown in FIG. 14 to be obtained.

Thus, according to the present invention, reproducing element marker 11 is formed simultaneously with reproducing element 7. Furthermore, recording element marker 12 is formed simultaneously with recording element 8. The positions of reproducing element marker 11 and recording element marker 12 are then optically sensed. Thus, on the basis of the sensing results, the present invention enables correction of the misalignment between reproducing element 7 and recording element 8, that is, the misalignment between reproducing element 7 and recording element 8 during formation, or the misalignment resulting from the deviation of the posture of the bar 14 in which bar 14 is attached to processing jig 15. As a result, pressing air bearing surface 13 of bar 14 against grinding machine 16 enables bar 14 to be polished such that both magnetic pole length La of reproducing element 7 and magnetic pole length Lb of recording element 8 can be set to the desired values.

Reproducing element marker 11 and recording element marker 12 are not involved in writing or reading of magnetic information to or from completed magnetic head 2. Thus, reproducing element marker 11 and recording element marker 12 can be formed to have any shapes and sizes. Reproducing element marker 11 and recording element marker 12 can be formed in shapes and sizes that can be easily detected by optical sensor 17. Consequently, the use of reproducing element marker 11 and recording element marker 12 allows possible misalignment to be more easily sensed than direct sensing of the positions of reproducing element 7 and recording element 8 by optical sensor 17. This significantly improves operational efficiency.

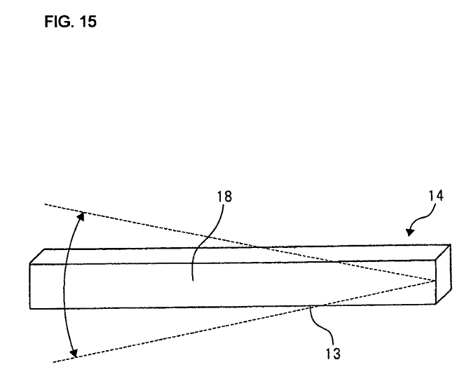

In the above-described example, the positions of reproducing element marker 11 and recording element marker 12 are sensed from above element forming surface 18 of bar 14. Then, to correct the misalignment between the positions, as shown in FIGS. 8 to 10, the angle of bar 14 is adjusted in the surface perpendicular to each of element forming surface 18 and air bearing surface 13, to correct the posture of bar 14 in which bar 14 abuts against grinding machine 16. This corrects a variation in the positions of reproducing element 7 and recording element 8 in bar 14 and adjusts the angle of the element forming direction of bar 14. However, in addition, transmission images of reproducing element marker 11 and recording element marker 12 can be optically sensed from air bearing surface 13 side of bar 14. In this case, the misalignment between reproducing element marker 11 and recording element marker 12 as viewed from air bearing surface 13 side is determined. Then, to correct the misalignment, the angle of bar 14 can be adjusted in a surface parallel to element forming surface 18, that is, in the longitudinal direction of bar 14, as shown by an arrow in FIG. 15. According to this example, the misalignment between reproducing element marker 11 and recording element marker 12 is sensed from the two directions (the direction from element forming surface 18 side and the direction from air bearing surface 13 side). This enables more accurate posture adjustment and thus more accurate polishing.

Although not shown in the drawings, a recording element lapping marker may be provided in order to accurately form recording element 8 having magnetic pole length Lb. In this case, as described above, the positions of reproducing element marker 11 and recording element marker 12 are optically sensed to roughly adjust the angle of bar 14. Then, the recording element lapping marker is utilized to finely adjust the angle of bar 14, for example, during polishing. This enables more accurate polishing.

Now, a method of attaching bar 14 to processing jig 15 will be described.

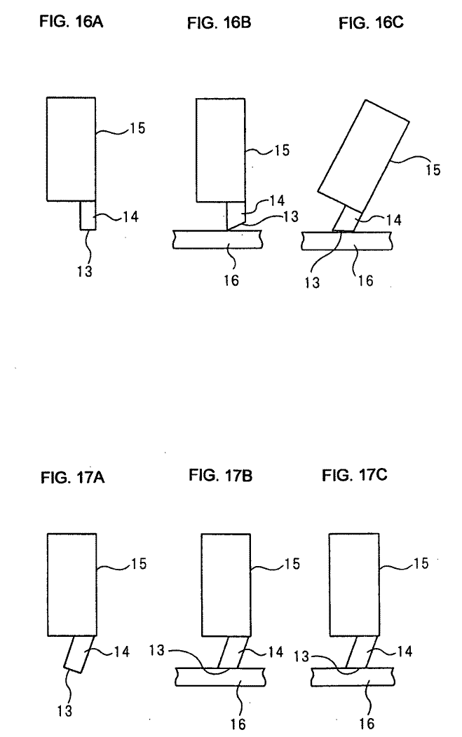

To be attached to processing jig 15, bar 14 is fixed perpendicularly to processing jig 15 as shown in FIG. 16A. Then, when the polishing target surface of bar 14 is first roughly polished, the polishing is performed without tilting processing jig 15 as shown in FIG. 16B. Then, when the polishing has progressed to some degree, the polishing rate is reduced to perform fine polishing. During fine polishing, processing jig 15 is tilted as shown in FIG. 16C. However, this method has disadvantages described below.

First, when processing jig 15 is tilted, some areas of the polishing target surface (air bearing surface 13) are readily polished, while the other areas are not readily polished. As a result, air bearing surface 13 may be composed of two surfaces (a polished portion and an unpolished portion) with slightly different angles. This reduces the yield of magnetic head 2. To avoid this, the polishing amount (polishing range) needs to be larger than required so as to allow entire air bearing surface 13 to be reliably polished, that is, to allow even a portion of air bearing surface 13 which is most difficult to polish (a portion located away from grinding machine 16) to be reliably polished. This may disadvantageously increase the time required for polishing and the amount of polishing slurry that will be consumed.

Furthermore, since processing jig 15 is tiltingly held during fine polishing, the processing rate may be unstable. This may finally reduce the accuracy of magnetic pole length La of reproducing element 7 and magnetic pole length Lb of recording element 8. Moreover, during rough polishing, since only an edge of bar 14 abuts against grinding machine 16, bar 14 or grinding machine 16 may be damaged.

To avoid these problems, bar 14 is firstly tilted and attached to processing jig 15 in the example shown in FIGS. 17A to 17C. This enables polishing of bar without tilting processing jig 15 with respect to grinding machine 18 in both rough polishing (see FIG. 17B) and fine polishing (see FIG. 17C). Consequently, surface machining can be easily performed parallel to grinding machine 16, thus preventing bar 14 and grinding machine 16 from being damaged. Furthermore, since processing jig 15 need not be tilted during polishing, air bearing surface 13 is prevented from being disadvantageously composed of two surfaces. Thus, the polishing amount (polishing range) need not be larger than required. The angle at which bar 14 is attached to processing jig 15 is desirably pre-calculated based on position data of reproducing element 7 and recording element 8 on substrate 1 and/or based on position data of reproducing element marker 11 and recording element marker 12 described above.

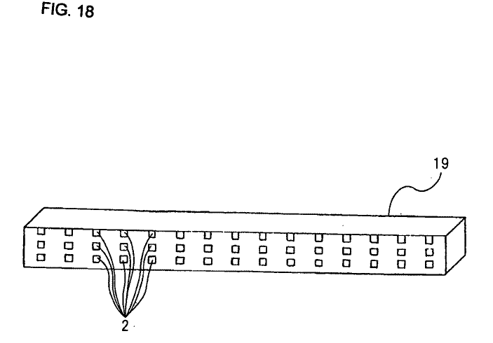

In the above-described example, substrate 1 is cut into a plurality of elongate bars 14 (see FIG. 5), and each of bars 14 is processed. However, as shown in FIG. 18, what is called stack lapping process can be performed in which each block (stack) 19 which is an assembly of a plurality of bars 14 is processed. In this case, substrate 1 is cut into blocks 19, each of which is an assembly of a number of bars, instead of being cut into elongate bars having a plurality of magnetic heads arranged therein. The subsequent steps may be carried out similarly to the above-described processing for each bar 14. Each block 19 may be handled to collectively process a plurality of bars 14.

While preferred embodiments of the present invention have been described using specific terms, such description is for illustrative purposes only, and it is to be understood that changes and variations may be made without departing from the spirit or scope of the following claims.

What is claimed is:

1. A method of manufacturing a magnetic head, the method comprising the steps of:
forming a plurality of magnetic heads on a substrate, each of said magnetic head including a reproducing element to read magnetic information, a recording element to write magnetic information, a reproducing element marker formed on the same plane as that on which said reproducing element is formed, and a recording element marker formed on the same plane as that on which said recording element is formed;
cutting said substrate to form a bar including a plurality of said magnetic heads;
determining a position of said reproducing element marker and a position of said recording element marker by holding said bar and optically sensing said reproducing element marker and said recording element marker in said bar which is held;
adjusting a posture of said bar which is held, based on said position of said reproducing element marker and said position of said recording element marker;
polishing said bar with the posture adjusted; and
cutting said bar which was polished into individual magnetic heads.

2. The method of manufacturing a magnetic head according to claim 1, wherein the step of determining a position of said reproducing element marker and a position of said recording element marker includes optically sensing transmission images, which are transmitted through a part of said magnetic head, of said reproducing element marker and said recording element marker that are not exposed from a surface of said magnetic head.

3. The method of manufacturing a magnetic head according to claim 1, wherein
the step of forming said magnetic head includes simultaneously forming said reproducing element and said reproducing element marker using the same material, and simultaneously forming said recording element and said recording element marker using the same material, and
a relative positional relationship between said reproducing element and said reproducing element marker is specified, and a relative positional relationship between said recording element and said recording element marker is specified.

4. The method of manufacturing a magnetic head according to claim 1, wherein
holding said bar is performed by attaching said bar to a processing jig, and
the step of adjusting a posture of said bar comprises adjusting the attachment posture in which said bar is attached to said processing jig.

5. The method of manufacturing a magnetic head according to claim 4, wherein the step of adjusting a posture of said bar comprises holding said bar by, if said position of said reproducing element marker and said position of said recording element marker are correctly aligned, attaching said bar to said processing jig with the posture of said bar adjusted such that said bar is located perpendicularly to said processing jig, and if said position of said reproducing element marker and said position of said recording element marker are misaligned, attaching said bar to said processing jig with the posture of said bar adjusted such that said bar is located obliquely to said processing jig at an angle corresponding to the misalignment.

6. The method of manufacturing a magnetic head according to claim 1, wherein the step of adjusting a posture of said bar includes adjusting an angle of said bar in a width direction and adjusting an angle of said bar in a longitudinal direction.

7. A magnetic head comprising a reproducing element to read magnetic information, a recording element to write magnetic information, a reproducing element marker formed on the same plane on which said reproducing element is formed, and a recording element marker formed on the same plane on which said recording element is formed.

8. The magnetic head according to claim 7, wherein
said reproducing element marker is formed simultaneously with said reproducing element using the same material as that of said reproducing element, and a relative positional relationship between said reproducing element and said reproducing element marker is specified, and
said recording element marker is formed simultaneously with said recording element using the same material as that of said recording element, and a relative positional relationship between said recording element and said recording element marker is specified.
